(19) United States
(12) Patent Application Publication
(10) Pub. No.: US 2005/0141830 A1
(43) Pub. Date: Jun. 30, 2005

(54) Methods of metallizing non-conductive substrates and metallized non-conductive substrates formed thereby

(75) Inventor: Timothy J. Peret, Rutland, MA (US)

Correspondence Address: EDWARDS & ANGELL, LLP, P.O. BOX 55874, BOSTON, MA, 02205, US

(73) Assignee: Rohm and Haas Electronic Materials LLC

(21) Appl. No.: 11/023,816

(22) Filed: Dec. 28, 2004

Related U.S. Application Data
(60) Provisional application No. 60/533,526, filed on Dec. 31, 2003.

(51) Int. Cl. G02B 6/36

(52) U.S. Cl. 385/94

(57) ABSTRACT

Disclosed are methods of metallizing non-conductive substrates. The methods involve: (a) providing a non-conductive substrate having an exposed non-conductive surface; (b) forming a first nickel layer over the exposed non-conductive surface by electroless plating; and (c) forming a second nickel layer over the first nickel layer by electrolytic plating with a solution having a pH of from 2 to 2.5. The non-conductive substrate can be, for example, an optical fiber. Also disclosed are metallized non-conductive substrates and metallized optical fibers prepared by the inventive methods, as well as optoelectronic packages that include such metallized optical fibers. Particular applicability can be found in the optoelectronics industry in metallization of optical fibers and in the formation of hermetic optoelectronic device packages.

### CROSS-REFERENCE TO RELATED APPLICATIONS

This application claims the benefit under 35 U.S.C. § 119(e) of U.S. Provisional Application No. 60/533,526, filed Dec. 31, 2003, the entire contents of which are incorporated herein by reference.

### BACKGROUND OF THE INVENTION

This invention relates to methods of metallizing non-conductive substrates. The invention also relates to non-conductive substrates having a metallized surface. Particular applicability can be found in the optoelectronics industry in metallizing optical fibers and in the formation of hermetic optoelectronic device packages which include a metallized optical fiber.

Signal transmission using pulse sequences of light is becoming increasingly important in high-speed communications. Optical fibers have been a cornerstone in the infrastructure required for optical communications. The optical fibers are typically connected to optoelectronic components such as laser diodes, light emitting diodes (LEDs), photodetectors, modulators, and the like, in a device package. The resulting glass-to-metal connection between the optical fiber and package creates a hermetically sealed structure. Hermetic packages provide for containment and protection of the enclosed devices, which are typically sensitive to environmental conditions. In this regard, degradation in operation of optical and optoelectronic components may be caused by atmospheric contaminants such as humidity, dust, chemical vapors, and free ions. The optical input/output surfaces of the components in the package are especially susceptible to contamination while metallic surfaces of the package are susceptible to corrosion. Both of these effects can give rise to reliability problems. Hermetic sealing of the package to prevent contact with the outside atmosphere is thus desired.

To allow bonding of the optical fiber to an optoelectronic device package and formation of a hermetic seal, a metal structure is formed on the non-conductive, silica surface of the optical fiber. Several techniques for metallizing optical fibers are known in the art. For example, the physical vapor deposition (PVD) techniques of sputtering and evaporation have been proposed. A typical metal structure formed by PVD includes a titanium or chrome adhesion layer, a platinum or nickel diffusion barrier, and a gold solder layer. The sputtering process is believed to weaken the glass fiber due to impinging ions and electrons on the fiber surface during deposition, leading to potential reliability problems later in the product lifetime. In addition, sputtering equipment is complex, expensive and produces a relatively non-uniform coating. Metallized structures formed by evaporation typically have poor adhesion to the glass, resulting in peeling of the metal from the fiber. Further, evaporation equipment, like sputtering equipment, is complex and expensive.

To address one or more problems associated with PVD techniques, the use of electroless and electrolytic plating processes has been proposed. For example, U.S. Pat. No. 6,251,252 discloses a method that involves sensitizing the silica surface of the optical fiber with a stannous fluoride solution, catalyzing the sensitized silica surface with a catalyzing solution comprising stannous chloride and hydrochloric acid, and activating the catalyzed silica surface with an activator solution comprising palladium chloride. A first nickel layer is deposited on the activated silica surface by immersion into an electroless nickel-plating solution. A second nickel layer is deposited by immersion into an electrolytic nickel-plating solution at a pH of 3.5 to 4.5 purportedly for further adhesion and corrosion resistance. A gold layer is deposited on the nickel layer by immersion into an electrolytic gold plating solution.

It is desirable for the metallization structure to have good ductility properties in addition to adhering to the glass fiber. In this regard, adhesion is desirable to prevent peeling of one or more of the metal layers, which can cause a loss of hermeticity and/or breakage of the solder joint connecting the fiber to the package. Ductility in the metal structure is beneficial to prevent cracking of the metallization structure and exposure of the silica surface when the fiber is bent. Greater ductility allows for improved workability of the metallized fiber in handling the fibers and assembling them into packages.

There is thus a continuing need in the art for improved methods of forming metallized fibers that overcome or conspicuously ameliorate one or more of the foregoing problems associated with the state of the art.

### SUMMARY OF THE INVENTION

In accordance with a first aspect, the present invention provides methods of metallizing non-conductive substrates. The methods involve: (a) providing a non-conductive substrate having an exposed non-conductive surface; (b) forming a first nickel layer over the exposed non-conductive surface by electroless plating; and (c) forming a second nickel layer over the first nickel layer by electrolytic plating with a solution having a pH of from 2 to 2.5. The non-conductive substrate can be, for example, an optical fiber.

In accordance with further aspects, the present invention provides metallized non-conductive substrates and metallized optical fibers prepared by the inventive methods.

In accordance with a further aspect, the present invention provides optoelectronic packages that include a metallized optical fiber prepared by the inventive methods.

Other features and advantages of the present invention will become apparent to one skilled in the art upon review of the following description, claims, and drawings appended hereto.

### BRIEF DESCRIPTION OF THE DRAWINGS

The present invention will be discussed with reference to the following drawings, in which like reference numerals denote like features, and in which:

FIG. 1 illustrates an exemplary metallized optical fiber formed in accordance with one aspect of the invention; and

FIG. 2 illustrates an optoelectronic package in accordance with a further aspect of the invention.

### DETAILED DESCRIPTION OF THE INVENTION

The present invention provides methods of metallizing non-conductive substrates such as optical fibers, lenses, other optical elements, and non-conductive substrates in general. While the methods of the invention will be described with reference to optical fiber metallization, it should be clear that the principles are more broadly applicable to metallization of nonconductive substrate in general. Typical nonconductive substrate materials include, for example, thermosetting or thermoplastic resins, silica, doped silica, glass and doped glass. Further, while various processes are discussed in terms of immersion of the optical fiber into chemical baths, other techniques for contacting the fiber with chemicals are envisioned, for example, by spraying the chemicals in liquid or atomized form. Also, as used herein, the terms “a” and “an” mean one or more. The methods of the invention involve providing a non-conductive substrate having a non-conductive surface, forming a first nickel layer over the non-conductive surface by electroless plating, and forming a second nickel layer over the first nickel layer by electrolytic plating with a solution having a pH of from 2 to 2.5. The methods allow for metallization of optical fibers, making them solderable to other components and device packages such as hermetic packages. Metallized structures such as optical fibers having good adhesion and ductility properties can result from the methods.

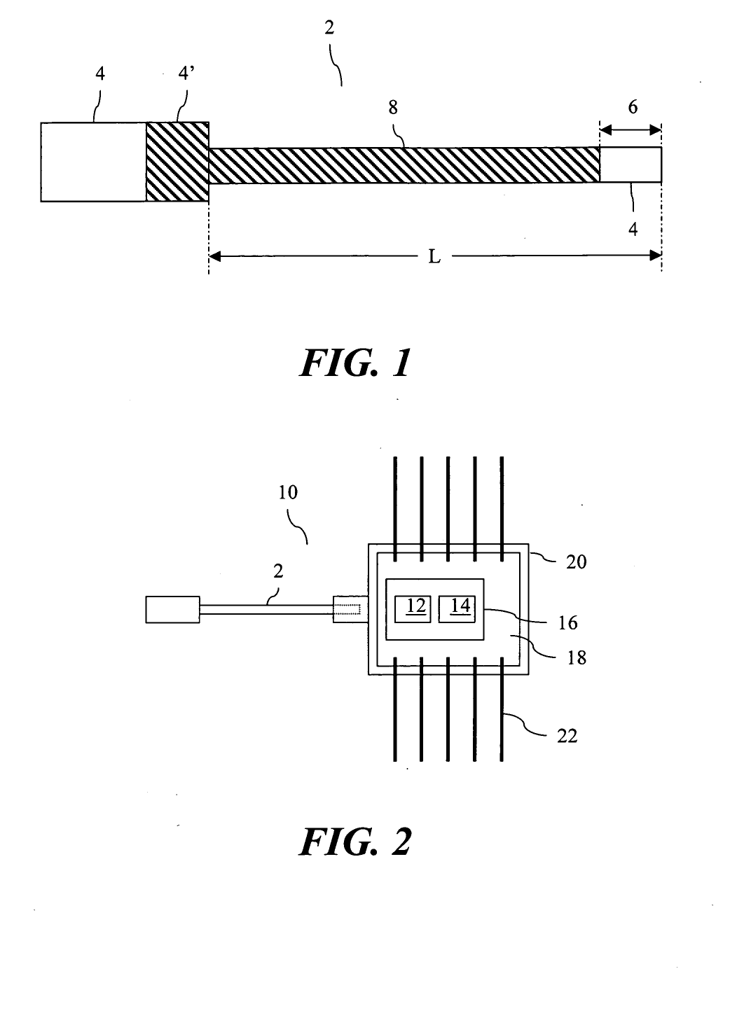

With reference to FIG. 1, which illustrates an exemplary metallized optical fiber 2 formed in accordance with one aspect of the invention, the optical fiber to be metallized includes a core surrounded by a clad, both typically formed of a glass, e.g., silica. Typically, a polymeric jacket 4, such as an acrylate, surrounds the clad. In preparation of metallization, a desired length L of the polymeric jacket is stripped from that portion of the fiber to be metallized, thereby exposing the glass surface of the clad. The portion of the fiber to be metallized is typically an end portion, but may be another portion, for example, a central portion of the fiber. In certain circumstances, for example, continuous reel-to-reel-type processes, it may be desirable to strip the jacket from the entire length of the fiber (alternatively, a jacket-free fiber may be used in this instance). Mechanical and/or chemical stripping techniques may be employed. Chemical stripping may be more beneficial as it can reduce or eliminate glass nicking which may lead to microcrack formation and reliability issues over the lifetime of the product. The particular chemical used for stripping will depend on the jacket material. In the case of an acrylate jacket, for example, contact with a concentrated (e.g., about 95 wt %) sulfuric acid solution at 150 to 190° C., for a time effective to completely remove the jacket may be used. The stripping time will depend, for example, on the specific jacket material, thickness, and temperature and concentration of the acid solution. A typical stripping time is from 10 seconds to 90 seconds. The stripped portion of the fiber is next rinsed in deionized water for a time effective to remove residual acid from the fiber, for example, from 45 seconds to two minutes, and the fiber is typically then dried to de-swell the acrylate. The drying may be conducted under ambient conditions, typically for about 60 seconds.

A first nickel layer is next applied to the exposed glass surface of the fiber by an electroless plating process. Typically, the first nickel layer and subsequently deposited metal layers are also deposited over a portion or portions of the jacket 4′ adjacent the exposed glass surface, to seal the interface between the cladding and the jacket. The electroless plating process is typically performed as a series of steps including, for example, sensitizing, activating, and plating, although it is possible to combine one or more of these together. The process optionally includes a step in which exposed silica portions of the fiber are first microetched by immersion in an acid such as 10 wt % hydrofluoric acid at room temperature followed by a deionized water rinse. Such a microetch treatment serves to increase adhesion of the seed layer, formed during a subsequent sensitizing step, to the glass surface. This microetch step may optionally be conducted during the sensitizing step, for example, with the stannous fluoride sensitizing process described below.

The optical fiber exposed portion is next immersed into an aqueous sensitizing solution containing a stannous halide such as stannous chloride or stannous fluoride typically at ambient temperature, followed by a deionized water rinse to remove unadsorbed stannous halide. A sensitizer coating is thus formed on the fiber. Stannous chloride and stannous fluoride sensitizing solutions and techniques useful in the invention are known in the art and are described, for example, in U.S. Pat. Nos. 6,355,301 and 5,380,559, respectively, the contents of which are incorporated herein by reference. The stannous chloride solution may, for example, have from 5 g/L to 20 g/L stannous chloride in acidified deionized water containing, for example, 40 mL of 35 wt % hydrochloric acid per liter. The stannous fluoride solution may, for example, have a concentration of about 1 g/L stannous fluoride in water. While the immersion time in the sensitizing bath will depend, for example, on the particular bath chemistry, times of from 3 to 10 minutes are typical. When using a stannous fluoride sensitizing process, the sensitizing and subsequent activation step may be conducted in an inert atmosphere such as a nitrogen atmosphere to extend the lifetime of the baths.

The sensitized portion of the fiber is next immersed in an aqueous activating solution typically at room temperature, followed by a deionized water rinse and drying of the fiber including jacket. During this immersion, the stannous halide sensitizer coating reacts with the activating solution, causing deposition of palladium or other noble metal from the solution over the sensitizer coating. Suitable activating solutions are described, for example, in the aforementioned U.S. Pat. Nos. 5,380,559 and 6,355,301. The activating solution typically is an aqueous solution containing palladium (or other noble metal) chloride and dilute hydrochloric acid, for example, an aqueous solution containing from 0.1 to 10 g/L palladium chloride in dilute aqueous hydrochloric acid. The acid strength is typically from 0.01 M to 0.1 M hydrochloric acid, for example, 0.03 M hydrochloric acid. The immersion time will depend on the bath chemistry, but is typically from 1 to 6 minutes. Suitable activation chemistries and components are commercially available, for example, Ronamerse SMT™ catalyst, from Shipley Company, L.L.C., Marlborough, Mass., USA.

Optionally, portions of the fiber 6 can be masked to prevent metal layer formation thereon during subsequent processing. For example, prevention of metal film formation on the end of the fiber is generally desired. Masking techniques are known in the art and described, for example, in the aforementioned U.S. Pat. Nos. 5,380,559 and 6,355,301. The masking may be accomplished chemically by selective deactivation of previously activated portions of the fiber using, for example, an acidified aqueous solution of stannous halide such as used for sensitizing. Alternatively, the activated portion of the fiber to be masked can be coated with a strippable polymer to provide mechanical deactivation of the fiber. Such a coating can be formed, for example, from a solution composed of KEL-F 800 resin, available from 3M Corporation, in amyl acetate. The coating is dried in moving air at 75° C. for a period of from about five to about ten minutes. Further, there are commercially available plating mask mixtures available.

A first nickel layer is next deposited on the activated portions of the fiber by immersing the activated portions in an electroless nickel plating bath. Suitable components and chemistries are known in the art and described, for example, in the aforementioned U.S. Pat. Nos. 5,380,559 and 6,355,301. Electroless plating chemistries are commercially available, for example, the Everon™ BP electroless plating process from Shipley Company, L.L.C., NIMUDEN SX from Uyemura International Corporation, and type 4865 from Fidelity Chemical Products Corporation, Newark, N.J., USA. These commercial electroless nickel plating chemistries are typically two-part compositions containing nickel sulfate and sodium hypophosphate. A further suitable electroless plating chemistry includes from 30 to 35 g/L of nickel sulfate, from 15 to 20 g/L sodium hypophospite, from 80 to 90 g/L sodium citrate, and from 45 to 55 g/L ammonium chloride, at a temperature from 80 to 90° C. A further electroless nickel plating chemistry is described in U.S. Pat. No. 6,251,252 as containing 1 part sodium fluoride, 80 parts sodium succinate, 100 parts nickel sulfate, and 169 parts sodium hypophosphite with 500 parts deionized water, at a temperature of about 130° F. (54° C.). This first nickel layer functions as a seed layer for the second, electrolytic nickel layer to be formed. The thickness of the first nickel layer is typically from 0.25 to 2 μm so as not to contribute significantly to the overall ductility of the metal structure. After reaching the target film thickness, the fiber is removed from the plating bath and is rinsed with deionized water.

A second nickel layer is next formed over the first nickel layer by immersing the metallized fiber portion into an electrolytic plating bath and electrolytically plating the fiber. The pH of the electroplating plating bath is maintained in a range of from 2 to 2.5. The bath contains a nickel complex and a nickel salt, for example, from 75 g/L to 400 g/L of nickel as a nickel complex, such as NiSO₄.6H₂O or Ni(NH₂SO₃)₂ and from 3 g/L to 15 g/L of a nickel chloride salt such as NiCl₂.6H₂O. The bath may contain from 30 g/L to 45 g/L of a buffer such as boric acid as a buffer salt, and from 0.25 to 2 wt %, for example, from 0.5 to 2 wt %, of a commercially available wetting agent, for example, a perfluorinated quaternary amine wetting agent such as perfluoro dodecyl trimethyl ammonium fluoride. The bath may contain 5 ml/l to 20 ml/l of the wetting agent based on an aqueous solution that contains 10 ppm of the perfluorinated quaternary amine. Further, the bath may contain 30 ppm or less of particular metal impurities, for example, iron, copper, tin, zinc, and lead. The thickness of the second nickel layer is typically from 1 to 6 μm, for example, from 2 to 4 μm or about 3 μm. The bath temperature is typically from 50 to 65° C. If necessary to lower the pH to the desired value, a 20 wt % diluted sulfamic acid solution may be used. It is believed that lowering of the pH to a value of 2 to 2.5 results in a more ductile nickel layer than is obtained at higher values.

One or more additional metal layers may be coated over the second nickel layer using known techniques to impart desired characteristics to the metal structure. For example, one or more metal chosen from gold, palladium, silver, and alloys thereof, may be used to prevent oxidation of the structure. The additional layers may, for example, be formed over the second nickel layer using immersion plating and/or electrolytic plating. It may be desire to further deposit a tin or tin-alloy layer to enhance solderability of the metallization structure. Such layer can be formed by known techniques such as electrolytic plating. The thickness of the additional metal layers will depends, for example, on the specific material and coating technique. Through the foregoing techniques, a metallization structure 8 can be formed on a non-conductive substrate.

In accordance with a further aspect of the invention, optoelectronic packages are provided. The optoelectronic package may be, for example, a butterfly package, a silicon optical bench, or the like. This aspect of the invention will be described with reference to FIG. 2, which illustrates an exemplary butterfly package 10. The package include one or more metallized optical fiber 2 as described above and one or more optoelectronic device 12, 14. The optical fiber 2 and optoelectronic device 12, 14 are in optical communication with one another, and the package is typically hermetically sealed. The optoelectronic device may be, for example, a laser diode, an LED, a photodetector, a modulator, or a combination thereof. In the exemplified package, the optoelectronic devices are a laser diode 12 and photodetector 14. The optoelectronic devices are bonded to a submount 16 which may be, for example, a ceramic or silicon. The submount 16 in turn is bonded to the package casing bottom surface 18. The package casing 20 is typically formed of a metal such as KOVAR, CuW, a ceramic such as a low temperature cold-fired ceramic (LTCC), or a semiconductor such as silicon or gallium arsenide. Leads 22 are provided through the sidewalls of the package casing for providing electrical connection between the package and external components. The package may include other components such as wavelength lockers, backfacet monitors, electrical devices, electronic devices, lenses, mirrors, and the like, which are also bonded to the submount. The substrate may be bonded to a temperature-regulating device (not shown) such as a thermo-electric cooler (TEC) to control the package temperature. A package lid (not shown) and the metallized fiber 20 are bonded in place through soldering techniques to hermetically seal the package. The metallized optical fiber is aligned to the optoelectronic device, actively or passively, before and/or after being bonded into place.

The following prophetic example is intended to further illustrate the present invention, but is not intended to limit the scope of the invention in any aspect.

### EXAMPLE

A two meter SMF28 single mode optical fiber, commercially available from Corning Inc., Corning, N.Y., having an acrylate jacket is provided. The acrylate jacket is removed from one end of the fiber over a length of 5 cm by immersion of the fiber end in a 95 wt % sulfuric acid solution at 180° C. for one minute. The exposed end of the fiber is introduced into a deionized water bath for 90 seconds to remove residual acid from the fiber and the fiber and jacket are dried.

The fiber end is next immersed for eight minutes at room temperature in an aqueous stannous chloride sensitizing bath, formed by adding 10 g stannous chloride to 40 mL of 35 wt % hydrochloric acid in deionized water, and diluting to 1 L with deionized water. The fiber end is next rinsed in a deionized water bath for three minutes.

The sensitized fiber end is next immersed for three minutes at room temperature in an aqueous palladium chloride activating bath, formed by adding 0.25 g palladium chloride to 100 mL of 0.3M hydrochloric acid, and diluting to 1 L with deionized water. The activated fiber end is next rinsed in a deionized water bath for five minutes and the fiber including jacket is dried.

An end of the dried fiber is dipped into a strippable polymer to provide a coating protective against the metallization of the end of the fiber, and is dried in moving air at 75° C. for eight minutes.

A layer of nickel is next deposited on the activated fiber surface by electroless plating. The activated portion of the fiber is treated in an electroless nickel solution formed from 1 part sodium fluoride, 80 parts sodium succinate, 100 parts nickel sulfate, and 169 parts sodium hypophosphite with 500 parts deionized water, at a temperature of about 54° C., for a time to form a 0.75 μm nickel coating. The fiber is rinsed in deionized water.

A second layer of nickel 3 μm in thickness is formed over the first layer by electrolytic plating. The electrolytic plating bath is formed by combining 120 g of nickel as a nickel complex, Ni(NH₂SO₃)₂, 5 g of a nickel salt (NiCl₂6H₂O), and 30 g of a buffer, H₃BO₃, and diluting the mixture to one liter volume with deionized water. 20 mL/L of an aqueous solution containing 10 ppm perfluoro dodecyl trimethyl ammonium fluoride is added to the mixture. The bath temperature is maintained at 60° C. and the bath pH is 2 during plating. The bath is agitated at a rate of 25 cm/sec.

The nickel-coated fiber is next immersed for 10 minutes in an electroless gold plating solution with stirring at 70° C., followed by rinsing in deionized water. The end of the acrylate jacket is blown dry with air at 75° C. for 10 minutes.

It is expected that the resulting metallized structure has a combination of excellent adhesion and ductility characteristics.

While the invention has been described in detail with reference to specific embodiments thereof, it will be apparent to one skilled in the art that various changes and modifications can be made, and equivalents employed, without departing from the scope of the claims.

1. A method of metallizing a non-conductive substrate, comprising:
(a) providing a non-conductive substrate having an exposed non-conductive surface;
(b) forming a first nickel layer over the non-conductive surface by electroless plating; and
(c) forming a second nickel layer over the first nickel layer by electrolytic plating with a solution having a pH of from 2 to 2.5.

2. The method of claim 1, wherein the exposed non-conductive surface is a glass surface.

3. The method of claim 2, wherein the non-conductive substrate is an optical fiber.

4. The method of claim 3, wherein (b) comprises:
(b¹) sensitizing the glass surface with a sensitizing solution prepared by combining a stannous halide with water;
(b²) activating the sensitized glass surface with an activating solution prepared by combining palladium chloride and water; and
(b³) depositing the first nickel layer on the activated glass surface by electroless plating.

5. The method of claim 3, wherein the first nickel layer is deposited to a thickness of from 0.5 to 2 μm.

6. The method of claim 5, wherein the second nickel layer is deposited to a thickness of from 2 to 4 μm.

7. The method of claim 3, further comprising forming a metal layer over the second nickel layer, wherein the metal layer is formed of a material chosen from gold, palladium, silver, and alloys thereof.

8. The method of claim 7, wherein the metal layer is a gold layer.

9. The method of claim 8, wherein the gold layer is formed by immersion plating.

10. The method of claim 9, wherein the first nickel layer is deposited to a thickness of from 0.5 to 2 μm.

11. The method of claim 10, wherein the second nickel layer is deposited to a thickness of from 2 to 4 μm.

12. A metallized non-conductive substrate, formed by the method of claim 1.

13. A metallized optical fiber, formed by the method of claim 3.

14. A metallized optical fiber, formed by the method of claim 8.

15. An optoelectronic package, comprising a metallized optical fiber of claim 13 and an optoelectronic device.

16. The optoelectronic package of claim 14, wherein the package is hermetically sealed.
